(19) United States
(12) Patent Application Publication
(10) Pub. No.: US 2014/0008354 A1
(43) Pub. Date: Jan. 9, 2014

(54) METHOD AND SYSTEM OF USING INDUCTION HEATING TO HEAT CONSUMABLE DURING HOT WIRE PROCESS

(71) Applicant: LINCOLN GLOBAL, INC., City of Industry, CA (US)

(72) Inventors: Peter PLETCHER, Solon, OH (US); Steven R. SUMNER, Brunswick, OH (US); Michael BARRETT, North Royalton, OH (US)

(73) Assignee: LINCOLN GLOBAL, INC., City of Industry, CA (US)

(21) Appl. No.: 13/791,085

(22) Filed: Mar. 8, 2013

Related U.S. Application Data
(60) Provisional application No. 61/668,836, filed on Jul. 6, 2012.

(51) Int. Cl. H05B 6/02

(52) U.S. Cl. CPC H05B 6/02
USPC 219/602

(57) ABSTRACT

A system and method for use in brazing, cladding, building up, filling, overlaying, welding, and joining applications is provided. The system includes a high intensity energy source configured to heat at least one workpiece to create a molten puddle and a feeder system that includes a wire feeder configured to feed a consumable to the molten puddle. The system also includes an induction system which receives the consumable and induction-heats a length of the consumable prior to that part of the consumable entering the molten puddle. The method includes heating at least one workpiece to create a molten puddle and feeding a consumable to the molten puddle. The method also includes induction-heating a length of the consumable prior to that part of the consumable entering the molten puddle.

### PRIORITY

The present application claims priority to U.S. Provisional Patent Application No. 61/668,836, which is incorporated herein by reference in its entirety.

### TECHNICAL FIELD

Certain embodiments relate to induction heating filler wire in overlaying, welding and joining applications. More particularly, certain embodiments relate to a system and method that uses at least induction heating to heat filler wire in a combination filler wire feed and energy source system for any of brazing, cladding, building up, filling, hard-facing overlaying, joining and welding applications.

### BACKGROUND

The traditional filler wire method of welding (e.g., a gas-tungsten arc welding (GTAW) filler wire method) can provide increased deposition rates, high quality weld deposits and welding speeds over that of traditional arc welding alone. In such welding operations, the filler wire, which leads a torch, can be resistance-heated by a separate power supply. The wire is fed through a contact tube toward a workpiece and extends beyond the tube. The extension is resistance-heated to aid in the melting of the filler. A tungsten electrode may be used to heat and melt the workpiece to form the weld puddle. The power supply provides a large portion of the energy needed to resistance-melt the filler wire. In some cases, the wire feed may slip or falter and the current in the wire may cause an arc to occur between the tip of the wire and the workpiece. The extra heat of such an arc may cause burnthrough and spatter.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a system and method to use inductance heating to heat a filler wire as the filler wire is added to a molten puddle for a welding operation. The system includes a high intensity energy source configured to heat at least one workpiece to create a molten puddle and a feeder system that includes a wire feeder configured to feed a consumable to the molten puddle. The system also includes an induction system which receives the consumable and induction-heats a length of the consumable prior to that part of the consumable entering the molten puddle.

The method includes heating at least one workpiece to create a molten puddle and feeding a consumable to the molten puddle. The method also includes induction-heating a length of said consumable prior to that part of the consumable entering the molten puddle. In some embodiments, the method includes applying energy from a high intensity energy source to the workpiece to heat the workpiece at least while applying induction heating to the filler wire. The high intensity energy source may include at least one of a laser device, a plasma arc welding (PAW) device, a gas tungsten arc welding (GTAW) device, a gas metal arc welding (GMAW) device, a flux cored arc welding (FCAW) device, and a submerged arc welding (SAW) device.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a combination filler wire feeder and energy source system for any of brazing, cladding, building up, filling, hard-facing overlaying and welding applications;

FIG. 2 is a diagrammatical representation of an exemplary induction heating system of the present invention;

FIG. 3 is another diagrammatical representation of an exemplary induction heating system of the present invention;

FIG. 4 is diagrammatical representation of an exemplary brazing, cladding, building up, filling, hard-facing overlaying or welding system in accordance with an exemplary embodiment of the present invention;

FIG. 5 is a further diagrammatical representation of an exemplary brazing, cladding, building up, filling, hard-facing overlaying or welding system in accordance with an exemplary embodiment of the present invention;

FIG. 6 is an additional diagrammatical representation of an exemplary brazing, cladding, building up, filling, hard-facing overlaying or welding system in accordance with an exemplary embodiment of the present invention; and

FIG. 7 is a diagrammatical representation of another exemplary wire heating system in accordance with an exemplary embodiment of the present invention.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

It is known that welding/joining operations typically join multiple workpieces together in a welding operation where a filler metal is combined with at least some of the workpiece metal to form a joint. Because of the desire to increase production throughput in welding operations, there is a constant need for faster welding operations, which do not result in welds which have a substandard quality. This is also true for cladding/surfacing operations, which use similar technology. It is noted that although much of the following discussions will reference “welding” operations and systems, embodiments of the present invention are not just limited to joining operations, but can similarly be used for cladding, brazing, overlaying, etc.—type operations. Furthermore, there is a need to provide systems that can weld quickly under adverse environmental conditions, such as in remote work sites. As described below, exemplary embodiments of the present invention provide significant advantages over existing welding technologies. Such advantages include, but are not limited to, reduced total heat input resulting in low distortion of the workpiece, very high welding travel speeds, very low spatter rates, welding with the absence of shielding, welding plated or coated materials at high speeds with little or no spatter and welding complex materials at high speeds.

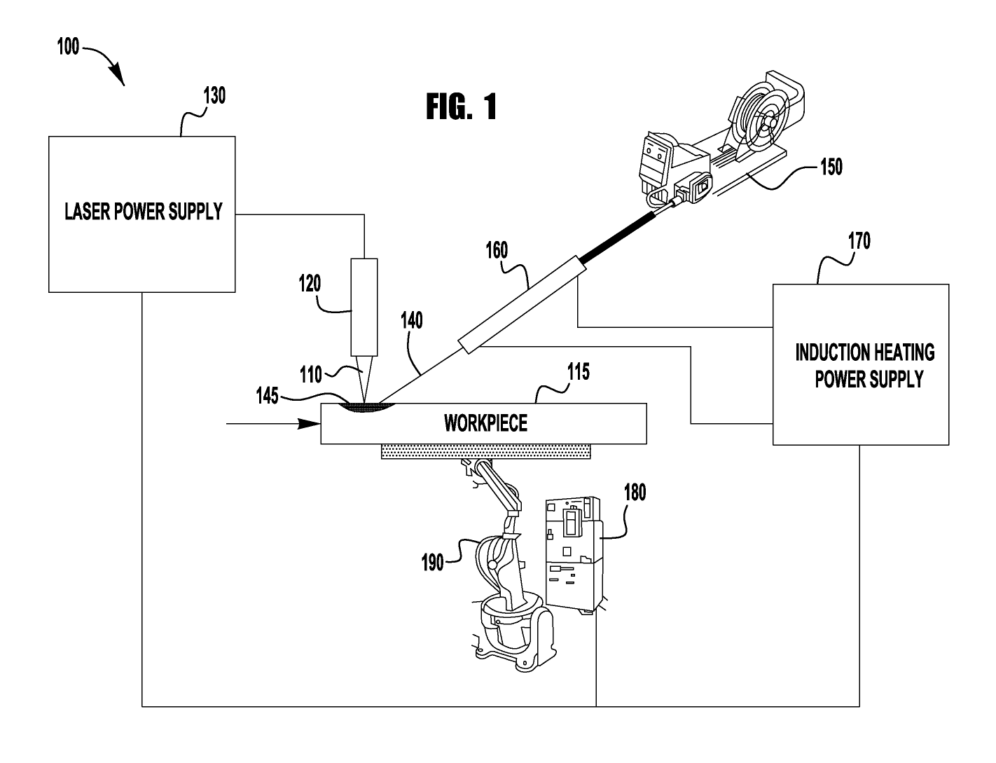

FIG. 1 illustrates a functional schematic block diagram of an exemplary embodiment of a combination filler wire feeder and energy source system 100 for performing any of brazing, cladding, building up, filling, hard-facing overlaying, and joining/welding applications. The system 100 includes a laser subsystem 130/120 capable of focusing a laser beam 110 onto a workpiece 115 to heat the workpiece 115. The laser subsystem is a high intensity energy source and laser beam 110 is of an energy density to melt portions of workpiece 115 creating a molten puddle, i.e., weld puddle 145. The laser subsystem can be any type of high energy laser source, including but not limited to carbon dioxide, Nd:YAG, Yb-disk, YB-fiber, fiber delivered or direct diode laser systems. Further, even white light or quartz laser type systems can be used if they have sufficient energy. Other embodiments of the system may include at least one of an electron beam, a plasma arc welding subsystem, a gas tungsten arc welding subsystem, a gas metal arc welding subsystem, a flux cored arc welding subsystem, and a submerged arc welding subsystem serving as the high intensity energy source. The following specification will repeatedly refer to the laser system, beam and power supply, however, it should be understood that this reference is exemplary as any high intensity energy source may be used. For example, a high intensity energy source can provide at least 500 W/cm². The laser subsystem includes a laser device 120 and a laser power supply 130 operatively connected to each other. The laser power supply 130 provides power to operate the laser device 120.

It should be noted that the high intensity energy sources, such as the laser devices 120 discussed herein, should be of a type having sufficient power to provide the necessary energy density for the desired welding operation. That is, the laser device 120 should have a power sufficient to create and maintain a stable weld puddle throughout the welding process, and also reach the desired weld penetration. For example, for some applications, lasers should have the ability to “keyhole” the workpieces being welded. This means that the laser should have sufficient power to fully penetrate the workpiece, while maintaining that level of penetration as the laser travels along the workpiece. Exemplary lasers should have power capabilities in the range of 1 to 20 kW, and may have a power capability in the range of 5 to 20 kW. Higher power lasers can be utilized, but can become very costly.

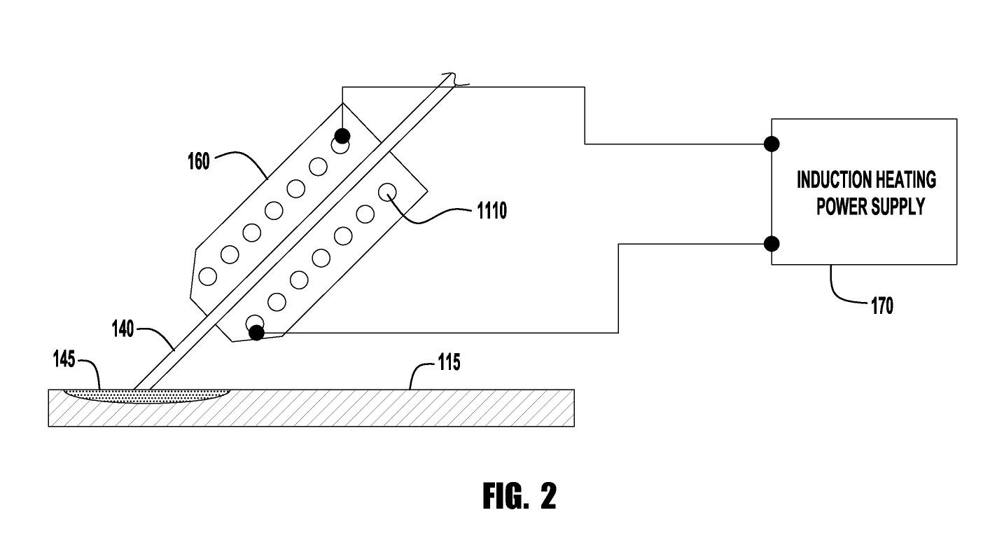

The system 100 also includes a hot filler wire feeder subsystem that includes a filler wire feeder 150, an induction tube 160, and an induction heating power supply 170. The hot filler wire feeder subsystem is capable of providing at least one resistive filler wire 140 to make contact with the workpiece 115 in the vicinity of the laser beam 110. In accordance with an embodiment of the present invention, the induction heating power supply 170 is an alternating current (AC) power supply that provides an AC current with an output frequency that is appropriate for the filler wire 140 being heated. As illustrated in FIG. 2, induction tube 160 houses induction coil 1110, which receives the AC current from the power supply 170. The flow of AC current through the coil 110 creates an alternating magnetic field that induces circulating eddy currents in the wire 140, which then heat the wire 140. In some exemplary embodiments, the induction coil 1110 is made of copper tubing and can be cooled by circulating water.

However, the present invention is not limited by the choice of materials and cooling for induction coil 1110 as long as filler wire 140 achieves the desired temperature. The induction coil 1110 may be integral to tube 160 or may be coiled around a surface of tube 160. Of course, the configuration of induction tube 160/induction coil 1110 is not limiting and other configurations may be used so long as the filler wire 140 achieves the desired temperature for welding operations.

During operation, the filler wire 140 is induction-heated by induction heating power supply 170, which is operatively connected to induction tube 160. The wire 140 is fed from the filler wire feeder 150 through the induction tube 160 toward the workpiece 115 and extends beyond the induction coil 160. The wire 140 is induction-heated such that the portion extending beyond induction tube 160 approaches or reaches the melting point before contacting the weld puddle 145 on the workpiece 115.

The filler wire 140 is directed to and impacts the weld puddle 145 to provide the needed filler material for the weld bead. Unlike most welding processes the filler wire 140 makes contact and is plunged into the weld puddle during the welding process. This is because this process does not use a welding arc to transfer the filler wire 140 but rather simply melts the filler wire into the weld puddle.

In an exemplary embodiment, the filler wire 140 impacts the weld puddle at the same location as the laser beam 110. However, in other exemplary embodiments the filler wire 140 can impact the same weld puddle remotely from the laser beam 110. In the embodiment shown in FIG. 1, motion controller 180, which is operatively connected to robot 190, moves workpiece 115 in the direction of the arrow. Thus, the filler wire 140 trails the beam 110 during the welding operation. However, that is not necessary as the filler wire 140 can be positioned in the leading position. The present invention is not limited in this regard, as the filler wire 140 can be positioned at other positions relative to the beam 110 so long as the filler wire 140 impacts the same weld puddle as the beam 110. Further, it is not necessary to have the wire 140 in line with the beam in the travel direction, but the wire can impinge the weld puddle 145 from any direction so long as suitable wire melting occurs in the puddle 145.

The filler wire 140 is preheated to at or near its melting point. Accordingly, its presence in the weld puddle 145 will not appreciably cool or solidify the puddle and is quickly consumed into the weld puddle 145. Because the filler wire 140 is inductively heated, there is no, or very little, heating current flowing into the workpiece 115. Therefore, the probability of an arc between filler wire 140 and the workpiece 115 is nearly zero.

The induction heating power supply 170 provides a large portion of the energy needed to inductively-melt the filler wire 140. However, the laser beam 110, which serves to melt some of the base metal of the workpiece 115 to form the weld puddle 145, may also help melt the wire 140 onto the workpiece 115. In a non-limiting embodiment, the induction heating power supply 170 will provide all or nearly all the energy needed to melt the filler wire 140. For example, in some exemplary embodiments, the induction heating power supply heats the filler wire 140 to within 85 to 95% of its melting temperature, whereby the remainder of the melting of the wire comes from the high energy heat source. The feeder subsystem may be capable of simultaneously providing one or more wires (not illustrated), in accordance with certain other embodiments of the present invention. For example, a first wire may be used for hard-facing and/or providing corrosion resistance to the workpiece, and a second wire may be used to add structure to the workpiece.

As described above, the induction heating power supply 170 is provided which inductively heats the filler wire 140 via induction coil 1110 (see FIG. 2). This induction heating causes the wire 140 to reach a temperature at or near the melting temperature of the filler wire 140 being employed, or at least to within 85 to 95% of the wire's melting temperature. Of course, the melting temperature of the filler wire 140 will vary depending on the size and chemistry of the wire 140. Accordingly, the desired temperature of the filler wire during welding will vary depending on the wire 140. As will be further discussed below, the desired operating temperature for the filler wire can be a data input into the welding system so that the desired wire temperature is maintained during welding. In any event, the temperature of the wire should be such that the wire is consumed into the weld puddle during the welding operation. In exemplary embodiments, at least a portion of the filler wire 140 is solid as the wire enters the weld puddle. For example, at least 30% of the filler wire is solid as the filler wire enters the weld puddle.

In another exemplary embodiment of the present invention, the induction heating power supply 170 maintains at least a portion of the filler wire at a temperature that is at or above 75% of its melting temperature. For example, when using a mild steel filler wire 140 the temperature of the wire before it enters the puddle can be approximately 1,600° F., whereas the wire has a melting temperature of about 2,000° F. Of course, it is understood that the respective melting temperatures and desired operational temperatures will varying on at least the alloy, composition, diameter and feed rate of the filler wire. In another exemplary embodiment, the power supply 170 maintains a portion of the filler wire at a temperature at or above 90% of its melting temperature. In further exemplary embodiments, portions of the wire are maintained at a temperature of the wire which is at or above 95% of its melting temperature. It is desirable to have the temperature percentages stated above to be measured on the wire at or near the point at which the wires enters the puddle. By maintaining the filler wire 140 at a temperature close to or at its melting temperature the wire 140 is easily melted into or consumed into the weld puddle created by the heat source/laser 120. That is, the wire 140 is of a temperature which does not result in significantly quenching the weld puddle 145 when the wire 140 makes contact with the puddle. Because of the high temperature of the wire 140, the wire 140 melts quickly when it makes contact with the weld puddle 145. It is desirable to have the wire temperature such that the wire 140 does not bottom out in the weld pool, i.e. make contact with the non-melted portion of the weld pool. Such contact can adversely affect the quality of the weld.

As described previously, in some exemplary embodiments, the complete melting of the wire 140 can be facilitated only by entry of the wire 140 into the puddle 145. However, in other exemplary embodiments the wire 140 can be completely melted by a combination of the puddle 145 and the laser beam 110 impacting on a portion of the wire 140. In yet other embodiments of the present invention, the heating/melting of the wire 140 can be aided by the laser beam 110 such that the beam 110 contributes to the heating of the wire 140. However, because many filler wires 140 are made of materials which can be reflective, if a reflective laser type is used, the wire 140 should be heated to a temperature such that its surface reflectivity is reduced, allowing the beam 110 to contribute to the heating/melting of the wire 140. In exemplary embodiments of this configuration, the wire 140 and beam 110 intersect at the point at which the wire 140 enters the puddle.

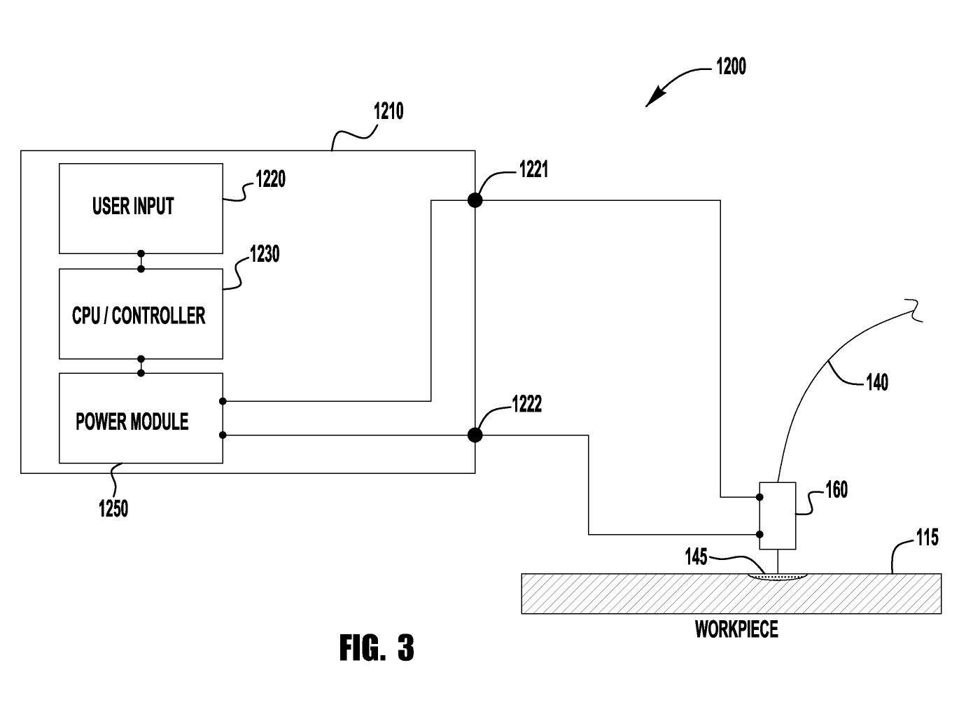

The above discussion can be further understood with reference to FIG. 3, in which an exemplary welding system is depicted (it should be noted that the laser system is not shown for clarity). The system 1200 is shown having an induction power supply 1210 (which can be of a type similar to that shown as 170 in FIG. 1). The power supply 1210 can be of a known induction power supply construction, such as an AC power supply. Because the design, operation and construction of such power supplies are known, they will not be discussed in detail herein. The power supply 1210 contains a user input 1220 which allows a user to input data including, but not limited to, wire feed speed, wire type, wire diameter, a desired power level, a desired wire temperature, frequency, voltage and/or current level. Of course, other input parameters can be utilized as needed. The user interface 1220 is coupled to a CPU/controller 1230 which receives the user input data and uses this information to create the needed operational set points or ranges for the power module 1250. The power module 1250 can be of any known type or construction.

The CPU/controller 1230 can determine the desired operational parameters in any number of ways, including using a lookup table. In such an embodiment, the CPU/controller 1230 utilizes the input data, for example, wire feed speed, wire diameter and wire type to determine the desired output level of induction heating by power supply 1210 to appropriately heat the wire 140. This is because the needed induction output to heat the wire 140 to the appropriate temperature will be based on at least the input parameters. That is, an aluminum wire 140 may have a lower melting temperature than a mild steel electrode, and thus requires less power to melt the wire 140. Additionally, a smaller diameter wire 140 will require less power than a larger diameter electrode. Also, as the wire feed speed increases (and accordingly the deposition rate) the needed power level to melt the wire will be higher.

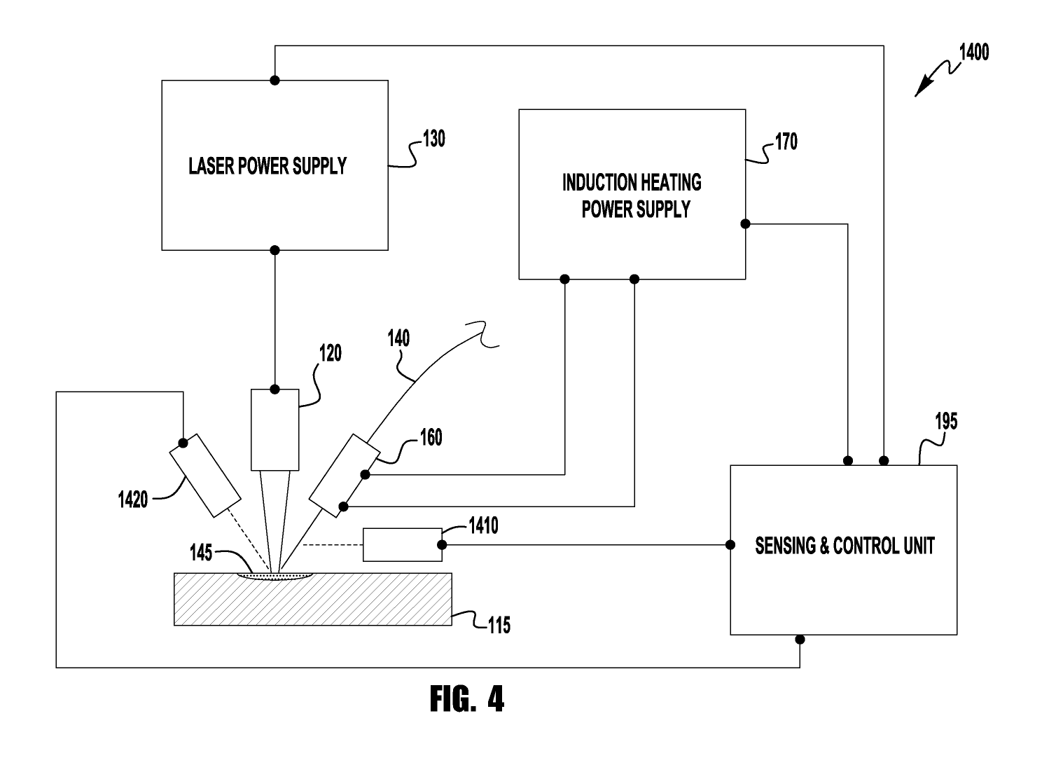

FIG. 4 depicts yet another exemplary embodiment of the present invention. FIG. 4 shows an embodiment similar to that as shown in FIG. 1. However, certain components and connections are not depicted for clarity. FIG. 4 depicts a system 1400 in which a thermal sensor 1410 is utilized to monitor the temperature of the wire 140. The thermal sensor 1410 can be of any known type capable of detecting the temperature of the wire 140. The sensor 1410 can make contact with the wire 140 or can be coupled to the induction tube 160 so as to detect the temperature of the wire. In a further exemplary embodiment of the present invention, the sensor 1410 is a type which uses a laser or infrared beam which is capable of detecting the temperature of a small object—such as the diameter of a filler wire—without contacting the wire 140. In such an embodiment the sensor 1410 is positioned such that the temperature of the wire 140 can be detected at the stick out of the wire 140—that is at some point between the end of the induction tube 160 and the weld puddle 145. The sensor 1410 should also be positioned such that the sensor 1410 for the wire 140 does not sense the temperature of weld puddle 145.

The sensor 1410 is coupled to a sensing and control unit 195 such that temperature feed back information can be provided to the induction heating power supply 170 and/or the laser power supply 130 so that the control of the system 1400 can be optimized. For example, the output of the induction heating power supply 170 can be adjusted based on at least the feedback from the sensor 1410. That is, in an embodiment of the present invention either the user can input a desired temperature setting (for a given weld and/or wire 140) or the sensing and control unit can set a desired temperature based on other user input data (wire feed speed, electrode type, etc.) and then the sensing and control unit 195 would control the output of at least the induction heating power supply 170 to maintain that desired temperature.

In such an embodiment it is possible to account for heating of the wire 140 that may occur due to the laser beam 110 impacting on the wire 140 before the wire enters the weld puddle 145. In embodiments of the invention, the temperature of the wire 140 can be controlled only via induction heating power supply 170. However, in other embodiments at least some of the heating of the wire 140 can come from the laser beam 110 impinging on at least a part of the wire 140. As such, the power from the power supply 170 alone may not be representative of the temperature of the wire 140. Accordingly, utilization of the sensor 1410 can aid in regulating the temperature of the wire 140 through control of the power supply 170 and/or the laser power supply 130.

In a further exemplary embodiment (also shown in FIG. 4) a temperature sensor 1420 is directed to sense the temperature of the weld puddle 145. In this embodiment, the temperature of the weld puddle 145 is also coupled to the sensing and control unit 195. Feedback from the sensor 1420 is used in calculating the desired temperature of wire 140 and thus, controlling the output of at least the induction heating power supply 170.

In another exemplary embodiment of the present invention, the sensing and control unit 195 can be coupled to a feed force detection unit (not shown) which is coupled to the wire feeding mechanism (not shown—but see 150 in FIG. 1). The feed force detection units are known and detect the feed force being applied to the wire 140 as it is being fed to the workpiece 115. For example, such a detection unit can monitor the torque being applied by a wire feeding motor in the wire feeder 150. If the wire 140 passes through the molten weld puddle 145 without fully melting it will contact a solid portion of the workpiece 115 and such contact will cause the feed force to increase as the motor is trying to maintain a set feed rate. This increase in force/torque can be detected and relayed to the control 195 which utilizes this information to adjust the output of induction heating power supply 170 to ensure proper melting of the wire 140 in the weld puddle 145.

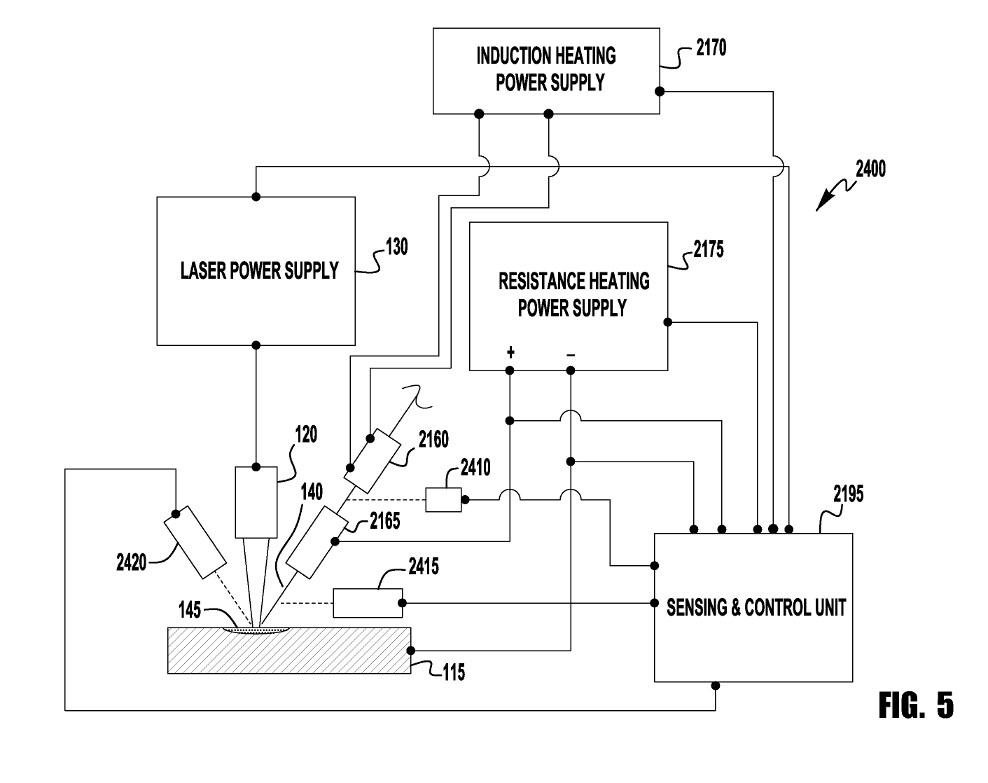

FIG. 5 illustrates another exemplary embodiment of the present invention (for clarity, some of the systems such as the wire feed mechanism are not shown). System 2400 includes a filler wire 140 that is heated using two tubes: an induction tube 2160 and a contact tube 2165. During operation, the filler wire 140 will first interact with induction tube 2160 which is operatively connected to induction heating power supply 2170. Induction tube 2160 and induction heating power supply 2170 are similar to induction tube 160 and induction heating power supply 170 discussed above and, for brevity, only the pertinent differences from the earlier embodiments will be discussed. In this embodiment, the induction tube 2160/power supply 2170 only heats the filler wire 140 to a threshold level, which can be predetermined, but the level is below the melting point of the wire. In such embodiments, the induction heating of the wire provides the majority of the heating of the wire, i.e., it provides over 50% of the energy needed to melt the filler 140. In some exemplary embodiments, the induction heating brings the filler 140 to within the range of 75 to 95% of its melting temperature. In yet a further exemplary embodiment, the induction heating brings the filler 140 to within the range of 85 to 95% of its melting temperature. The remaining energy needed to bring the wire to its melting temperature (or just below) is provided by resistance heating the wire 140 using contact tube 2165 and resistance heating power supply 2175.

By using resistance heating power supply 2175, sensing and control unit 2195 is able to provide more responsive control when heating wire 140 to the desired temperature. However, because a large portion of the power input to heat wire 140 is provided by induction heating, the resistance heating power supply 2175 need only provide a fraction of the current normally needed to resistively heat wire 140 to at or near its melting temperature. Accordingly, because the amount of current going into the workpiece 115 is relatively small, the risk of arcing is minimized.

The sensing and current control unit 2195 is operatively connected to the workpiece 115, the induction heating power supply 2170, resistance heating power supply 2175, laser power supply 130, and temperature sensors 2410, 2415, and 2120. The operation of control unit 2195 in connection with induction heating power supply 2170 is similar to that described above with respect to sensing and control unit 195 and induction heating power supply 170. However, in this embodiment, the sensing and control unit 2195 will control the output of induction heating power supply 2170 such that the temperature of wire 140 is maintained at the desired level after induction. It, of course, should be noted that since the induction heating has a stick-out which is larger than typical stick-out (because of its distance from the end of the filler 140), it may be needed to use an induction current level which compensates for any temperature drop due to this distance. Control unit 2195 may use the feedback from one or more temperature sensors 2410, 2415, and 2420 to make the necessary adjustments to induction heating power supply 2170 to maintain the temperature at the tip of induction tube 2160 at the desired temperature. Similarly, control unit 2195 may use the feedback from one or more temperature sensors 2410, 2415, and 2420 to control the output current from resistance heating power supply 2175 to maintain the temperature at the tip of contact tube 2165 at the desired temperature. In a non-limiting embodiment, the desired temperature at the tip of contact tube 2165 will be at or near the meting point of filler wire 140. The resistance heating power supply 2175 can be of any known construction which is capable of passing a current through the tip 2165, through the wire 140 and to the workpiece. Such power supplies are generally known, and because the majority of the heating of the wire comes from the induction heating, this resistance heating power supply need not be very large.

In addition, the control unit 2195 is capable of measuring a potential difference (i.e., a voltage V) between and a current (I) through the workpiece 115 and the consumable 140. The sensing and control unit 2195 may further be capable of calculating a resistance value (R=V/I) and/or a power value (P=V*I) from the measured voltage and current. In general, when the filler wire 140 is in contact with the workpiece 115, the potential difference between the filler wire 140 and the workpiece 115 is zero volts or very nearly zero volts. As a result, the sensing and control unit 2195 is capable of sensing when the filler wire 140 is in contact with the workpiece 115 and is operatively connected to the resistance heating power supply 2175 to be further capable of controlling the flow of current through the resistive filler wire 140 in response to the sensing such that during welding, along with controlling the temperature of wire 140, the wire 140 maintains contact with the workpiece and no arc is generated. In addition, application Ser. No. 13/212,025, titled “Method And System To Start And Use Combination Filler Wire Feed And High Intensity Energy Source For Welding” and incorporated by reference in its entirety, provides start-up and post start-up control algorithms that may be incorporated in sensing and control unit 2195.

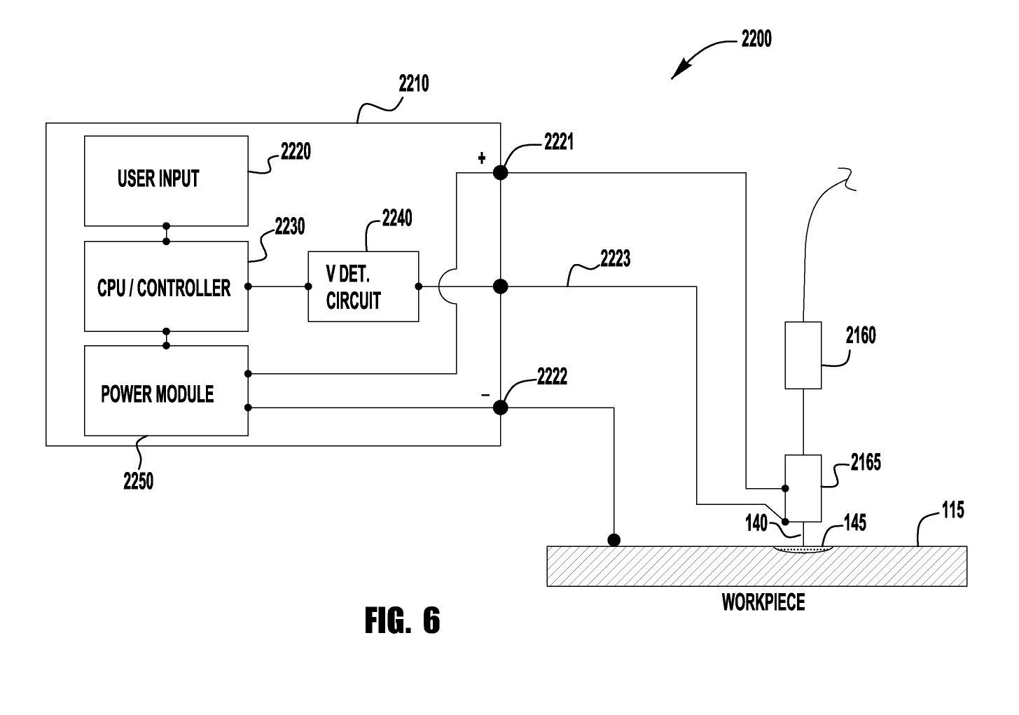

FIG. 6 illustrates another non-limiting embodiment of the present invention. System 2200 includes a resistance heating power supply 2210, which can be of a type similar to that shown as 2175 in FIG. 5. The power supply 2210 can be of a known welding power supply construction, such as an inverter-type power supply. Because the design, operation and construction of such power supplies are known they will not be discussed in detail herein. Similar to induction power supply 1210 discussed above, power supply 2210 contains a user input 2220 that allows a user to input data including, but not limited to, wire feed speed, wire type, wire diameter, a desired power level, a desired wire temperature, voltage and/or current level. Of course, other input parameters can be utilized as needed. The user interface 2220 is coupled to a CPU/controller 2230 which receives the user input data and uses this information to create the needed operational set points or ranges for the power module 2250. The power module 1250 can be of any known type or construction, including an inverter or transformer type module.

Similar to CPU/controller 1230 discussed above, CPU/controller 2230 can determine the desired operational parameters in any number of ways, including using a lookup table. CPU/controller 2230 utilizes the input data, for example, wire feed speed, wire diameter and wire type to determine the desired current level for the output (to appropriately heat the wire 140) and the threshold voltage or power level (or the acceptable operating range of voltage or power). The needed current to heat the wire 140 to the appropriate temperature will be based on at least the input parameters. Similar to CPU/controller 1230, CPU/controller 2230 accounts for the fact that fillers wires made of different materials and/or having different diameters will require different current/power settings to melt the filler wire. Of course, CPU/controller 2230 may also take into account the wire speed and the fact that wire 140 has been induction heated to a predetermined temperature at some percentage less that that of the melting temperature of the filler 140.

In addition, the input data will be used by the CPU/controller 2230 to determine the voltage/power thresholds and/or ranges (e.g., power, current, and/or voltage) for operation such that the creation of an arc is avoided. For example, for a mild steel electrode having a diameter of 0.045 inches can have a voltage range setting of 6 to 9 volts, where the power module 2250 is driven to maintain the voltage between 6 to 9 volts. In such an embodiment, the current, voltage, and/or power are driven to maintain a minimum of 6 volts—which ensures that the current/power is sufficiently high to appropriately heat the electrode—and keep the voltage at or below 9 volts to ensure that no arc is created and that a melting temperature of the wire 140 is not exceeded.

Of course, other set point parameters, such as voltage, current, power, or resistance rate changes can also be set by the CPU/controller 2230 as desired.

As shown, a positive terminal 2221 of the power supply 2210 is coupled to the contact tube 2165 and a negative terminal of the power supply 2210 is coupled to the workpiece 115. Thus, a heating current is supplied through the positive terminal 2221 to the wire 140 and returned through the negative terminal 2222. Such a configuration is generally known.

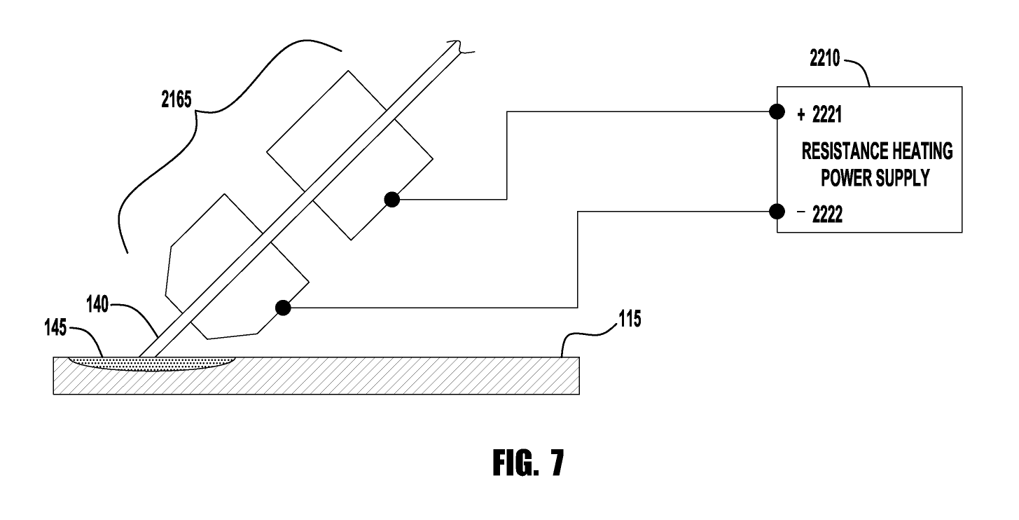

Of course, in another exemplary embodiment the negative terminal 2222 can also be connected to the contact tube 2165. Since resistance heating can be used to heat the wire 140, the contact tube 2165 can be of a construction where both the negative and positive terminals 2221/2222 can be coupled to the contact tube 2165 to heat the wire 140. For example, the contact tube 2165 can have a dual construction as shown in FIG. 7.

As illustrated in FIG. 6, feedback sense lead 2223 is also coupled to the power supply 2210. This feedback sense lead can monitor voltage and deliver the detected voltage to a voltage detection circuit 2240. The voltage detection circuit 2240 communicates the detected voltage and/or detected voltage rate of change to the CPU/controller 2230 which controls the operation of the module 2250 accordingly. For example, if the voltage detected is below a desired operational range, the CPU/controller 2230 instructs the module 2250 to increase its output (current, voltage, and/or power) until the detected voltage is within the desired operational range. Similarly, if the detected voltage is at or above a desired threshold the CPU/controller 2230 instructs the module 2250 to shut off the flow of current to the contact tube 2165 so that an arc is not created. If the voltage drops below the desired threshold the CPU/controller 2230 instructs the module 2250 to supply a current or voltage, or both to continue the welding process. Of course, the CPU/controller 2230 can also instruct the module 2250 to maintain or supply a desired power level.

It is noted that the detection circuit 2240 and CPU/controller 2230 can have a similar construction and operation as the sensing and control unit 2195 shown in FIG. 5. In exemplary embodiments of the present invention, the sampling/detection rate is at least 10 KHz. In other exemplary embodiments, the detection/sampling rate is in the range of 100 to 200 KHz.

In the above embodiments, the laser power supply, induction heating power supply, resistance heating power supply, and sensing and control unit are shown separately for clarity. However, in embodiments of the invention, these components can be made integral into a single welding system. Aspects of the present invention do not require the individually discussed components above to be maintained as separately physical units or stand alone structures.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. A system for induction-heating a consumable, said system comprising:
a high intensity energy source which heats at least one workpiece to create a molten puddle;
a feeder system comprising a wire feeder which feeds said consumable to said molten puddle; and
an induction system which receives said consumable and induction-heats a length of said consumable prior to said length of said consumable entering said molten puddle,
wherein said induction system comprises a power supply that supplies an output current, and
wherein said output current provides at least 50% of energy needed to melt said length of said consumable.

2. The system of claim 1, wherein said output current from said power supply is controlled based on at least one of a wire feed speed, a wire type, a wire diameter, a desired power level of said power supply, a desired consumable temperature, an output frequency of said power supply, a voltage output of said power supply, and a current output of said power supply.

3. The system of claim 1, wherein said output current provides 85% to 95% of said energy needed to melt said consumable.

4. The system of claim 1, wherein a portion of said energy needed to melt said consumable is provided by said high intensity energy source.

5. The system of claim 1, further comprising a second power supply operatively connected to said consumable to resistance-heat said consumable, wherein a portion of said energy needed to melt said consumable comes from said second power supply.

6. A system for induction-heating a consumable, said system comprising:
a high intensity energy source which heats at least one workpiece to create a molten puddle;
a feeder subsystem comprising a wire feeder which feeds said consumable to said molten puddle; and
an induction system which receives said consumable and induction-heats a length of said consumable prior to said length of said consumable entering said molten puddle,
wherein said induction system comprises a power supply that maintains said length of said consumable at a temperature that is at least 75% of a melting temperature of said consumable.

7. The system of claim 6, wherein said power supply maintains said temperature at or above 90% of said melting temperature of said consumable.

8. The system of claim 7, wherein said power supply maintains said temperature at or above 95% of said melting temperature of said consumable.

9. The system of claim 6, further comprising:
a second power supply operatively connected to said consumable to resistance-heat said consumable,
wherein a portion of said energy needed to melt said consumable comes from said second power supply.

10. The system of claim 9, further comprising at least one sensor to detect said temperature,
wherein said sensor is used to control at least one of an output of said power supply and an output of said second power supply.

11. A method for induction-heating a consumable, said method comprising:
heating at least one workpiece to create a molten puddle;
feeding said consumable to said molten puddle; and
induction-heating a length of said consumable prior to said length of said consumable entering said molten puddle,
wherein said induction-heating comprises supplying a current that provides at least 50% of energy needed to melt said length of said consumable.

12. The method of claim 11, wherein said supplying of said current is based on at least one of a wire feed speed, a wire type, a wire diameter, a desired power level of a power supply, a desired consumable temperature, an output frequency of said power supply, a voltage output of said power supply, and a current output of said power supply.

13. The method of claim 11, wherein said current provides 85% to 95% of said energy needed to melt said consumable.

14. The method of claim 13, wherein a portion of said energy needed to melt said consumable is provided by said molten puddle.

15. The method of claim 1, further comprising:
resistance-heating said consumable,
wherein a portion of said energy needed to melt said consumable comes from said resistance-heating.

16. A method of induction-heating a consumable, said method comprising:
heating at least one workpiece to create a molten puddle;
feeding said consumable to said molten puddle;
induction-heating a length of said consumable prior to said length of said consumable entering said molten puddle; and
controlling said induction heating to maintain said length of said consumable at a temperature that is at least 75% of a melting temperature of said consumable.

17. The method of claim 16, wherein said temperature is maintained at or above 90% of said melting temperature of said consumable.

18. The method of claim 17, wherein said temperature is maintained at or above 95% of said melting temperature of said consumable.

19. The method of claim 16, further comprising:
resistance-heating said consumable,
wherein a portion of said energy needed to melt said consumable comes from said resistance-heating.

20. The method of claim 19, further comprising:
sensing said temperature,
wherein at least one of said induction-heating and said resistance-heating is controlled based on said sensing said temperature.
